(19) United States
(12) Patent Application Publication
(10) Pub. No.: US 2011/0065327 A1
(43) Pub. Date: Mar. 17, 2011

(54) Electric fixture or connector

(75) Inventor: Hsing Kuang Chen, Taipei Hsien (TW)

(73) Assignee: Bestec Power Electronics Co., Ltd.

(21) Appl. No.: 12/586,110

(22) Filed: Sep. 17, 2009

(51) Int. Cl. H01R 24/00

(52) U.S. Cl. 439/660

(57) ABSTRACT

An electric fixture includes a housing having one or more orifices for engaging with conductor members each of which includes a ring member having an opening for engaging with a lead of an electrical wire, the lead of the electrical wire is easily and quickly engaged with the opening of the ring member and secured to the ring member by deforming the ring member for allowing the leads of the electrical wires to be easily and quickly and solidly connected or coupled or secured to the conductor member by the users themselves without special tools or the other mounting machines.

### BACKGROUND OF THE INVENTION

1. Field of the Invention

The present invention relates to an electric fixture or connector, and more particularly to an electric fixture or connector including an improved structure for easily and quickly and solidly connecting or coupling or assembling an electric wire to a conductor member or strip.

2. Description of the Prior Art

Typical electric fixtures or connectors, such as electric outlets, electric switches, electric sockets, electric plugs, etc. comprise an outer housing including one or more conductor members, conductor strips, contact pins, contact members, contact strips, prongs, adapter terminals, conducting strips etc. disposed or mounted therein for coupling to electric wires.

For example, U.S. Pat. No. 2,851,550 to Searcy discloses one of the typical remote control switches for electrical appliances also comprising one or more common conductor bars disposed or mounted in the outer housing and one or more contact pins or contact members coupled to the common conductor bars with fasteners or screws.

However, the fasteners or screws may not solidly secure or couple the contact pins or contact members to the common conductor bars, and it takes time for the users to secure or couple the contact pins or contact members to the common conductor bars with the fasteners or screws.

U.S. Pat. No. 3,079,475 to Rumble discloses the other typical electric plug also comprising one or more contact pins or ground pins having contacts for electrically connecting or coupling to leads with welding processes.

However, the users may not easily conduct the welding processes to electrically connect or couple the contact pins or ground pins to the leads.

U.S. Pat. No. 4,834,664 to Lin discloses another typical safety end-connector used for extension cord also comprising one or more contact or conducting strips disposed or mounted in a base for electrically and crampingly connecting or coupling to lead-in wires with special tools.

However, the lead-in wires may not be easily or quickly and crampingly connected or coupled to the contact or conducting strips with the special tools by the users themselves, the other mounting machines may be required to crampingly connect or couple the lead-in wires to the contact or conducting strips.

U.S. Pat. No. 5,030,119 to Lowe discloses another typical safety plug also comprising one or more adapter or electric terminals disposed or mounted in the outer housing for electrically and crampingly connecting or coupling to one or more conductors or terminals of an electrical cord.

However, similarly, the conductors or terminals of the electrical cord may not be easily or quickly and crampingly connected or coupled to the adapter or electric terminals by the users themselves.

The present invention has arisen to mitigate and/or obviate the afore-described disadvantages of the conventional electric fixtures or connectors.

### SUMMARY OF THE INVENTION

The primary objective of the present invention is to provide an electric fixture or connector including an improved structure for easily and quickly and solidly connecting or coupling or assembling an electric wire to a conductor member or strip.

In accordance with one aspect of the invention, there is provided an electric fixture comprising a housing including at least one orifice formed therein, a conductor member including an end portion disposed and mounted in the orifice of the housing, and including a ring member provided on the end portion of the conductor member, and including an opening formed in the ring member, and an electrical wire including a lead engaged with the opening of the ring member and secured to the ring member by deforming the ring member for allowing the leads of the electrical wires to be easily and quickly and solidly connected or coupled or secured to the conductor member by the users themselves without special tools or the other mounting machines.

The conductor member includes at least one aperture formed therein, and the housing includes at least one pin formed therein and engaged with the aperture of the conductor member for easily and quickly and solidly anchoring and securing the conductor members to the housing.

The housing includes a casing disposed beside the orifice of the housing for engaging with the end portion of the conductor member, and for stably anchoring and securing the conductor member to the housing.

The casing includes a slot formed therein for engaging with the lead of the electrical wire and for clamping or positioning or anchoring or securing the lead of the electrical wire to the casing of the housing.

The lead of the electrical wire may be bent for ninety (90) degrees and extended and engaged through the opening of the ring member of the conductor member after the lead of the electrical wire is engaged with the casing, and the ring member of the conductor member may then be cramped or clamped or distorted or deformed into various shapes and/or pinched onto the lead of the electrical wire for further solidly securing or mounting the lead of the electrical wire to the conductor members.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of an electric fixture or connector in accordance with the present invention;

FIG. 2 is a partial cross sectional view of the electric fixture or connector taken along lines 2-2 of FIG. 1;

FIG. 3 is a cross sectional view of the electric fixture or connector taken along lines 3-3 of FIG. 1;

FIG. 4 is a cross sectional view similar to FIG. 4 illustrating the electric fixture or connector having no electric wires disposed therein; and

FIGS. 5, 6, 7 are cross sectional views similar to FIG. 3 illustrating the assembling operation of the electric fixture or connector.

### DETAILED DESCRIPTION OF THE PREFERRED EMBODIMENT

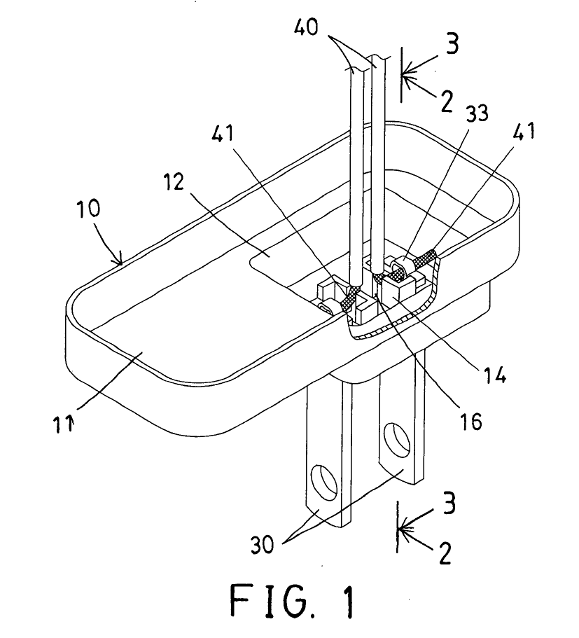

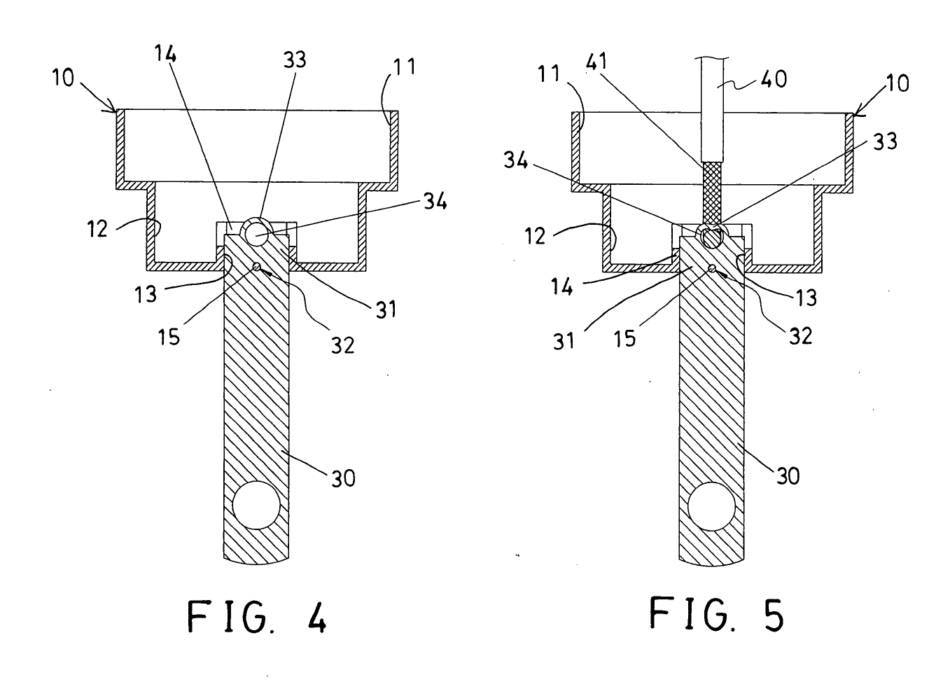

Referring to the drawings, and initially to FIGS. 1-4, an electric fixture or connector in accordance with the present invention comprises an outer housing 10 including a chamber 11 formed therein and/or including a compartment 12 formed therein and communicative with the chamber 11 of the housing 10, and including one or more (such as two or three) orifices 13 formed therein and communicative with the compartment 12 of the housing 10 and each orifice 13 is provided for receiving or engaging with a contact pin or contact member, a contact strip, an adapter terminal or conducting strip, an electric prong or conductor strip, or a conductor member 30 or the like and for anchoring or securing or mounting the conductor members 30 to the housing 10.

For example, one end or upper end portion 31 of the conductor members 30 may be disposed or mounted and secured in the orifices 13 of the housing 10 with a molding or mold-injection procedure or method, and the housing 10 may be molded or formed with a fence or casing 14 beside or around each orifice 13 for engaging with the one end or upper end portion 31 of the conductor members 30 and for stably anchoring or securing or mounting the conductor members 30 to the housing 10 and for preventing the conductor members 30 from being tilted or moved or rotated relative to the housing 10.

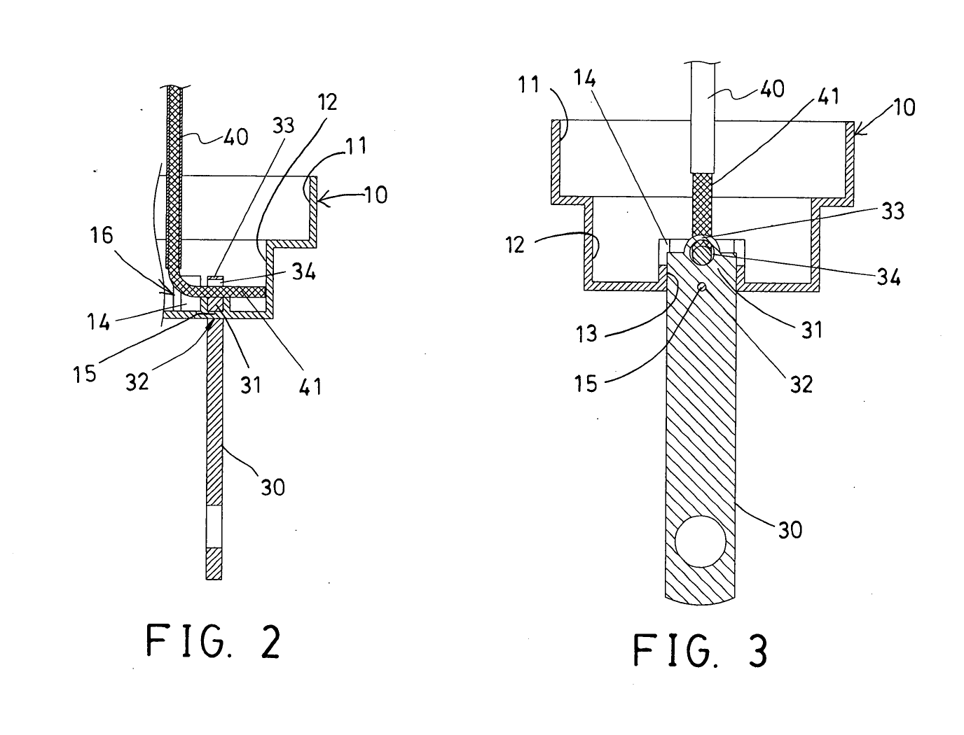

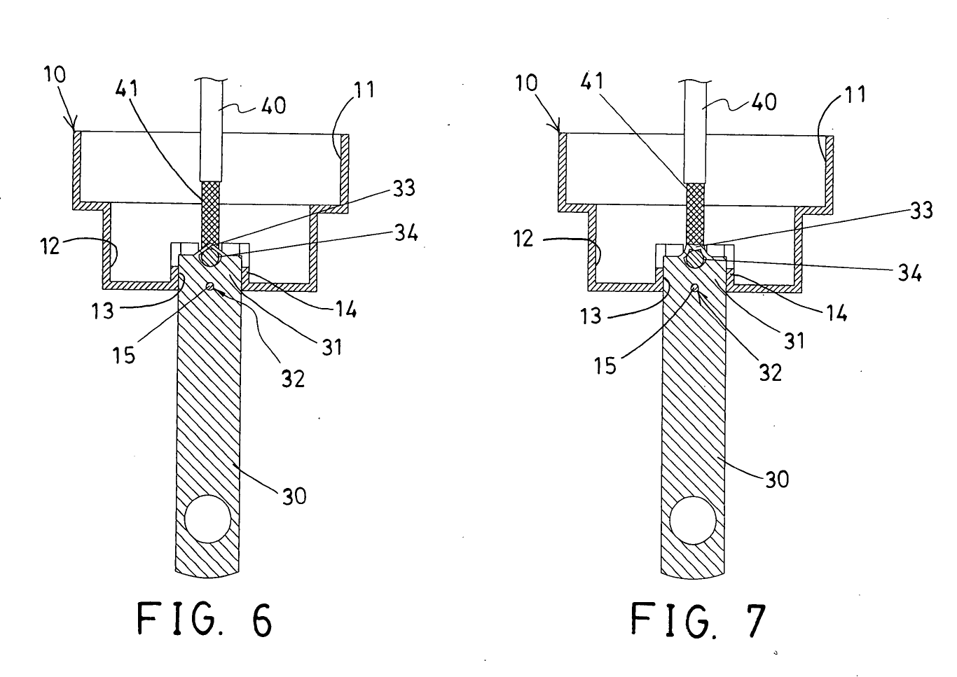

It is preferable that the conductor members 30 each further include one or more apertures 32 formed therein, such as formed in the one end or upper end portion 31 thereof, and the housing 10 may further include one or more molded pins 15 formed or molded therein and engaged with or through the apertures 32 of the conductor members 30, best shown in FIGS. 3-7, for further solidly anchoring or connecting or coupling or assembling or securing or mounting the conductor members 30 to the housing 10 and for preventing the conductor members 30 from being disengaged or detached or separated from the housing 10.

The conductor members 30 each further include a loop or curved or ring member 33 formed or provided on the one end or upper end portion 31 thereof, and having an opening 34 formed or provided in the ring member 33 for receiving or engaging with a terminal or lead 41 of an electrical cord or wire 40. It is preferable that the terminal or lead 41 of the electrical cord or wire 40 is engaged with the casing 14 of the housing 10, for example, the casing 14 of the housing 10 includes a slot 16 (FIGS. 1, 2) formed therein for receiving or engaging with the lead 41 of the electrical wire 40 and for anchoring or securing or mounting the lead 41 of the electrical wire 40 to the casing 14 of the housing 10. The lead 41 of the electrical wire 40 is then bent for about ninety (90) degrees and extended and engaged with or through the opening 34 of the ring member 33 of the conductor member 30 and/or contacted or engaged with the housing 10 (FIGS. 1, 2) for further solidly anchoring or connecting or coupling or assembling or securing or mounting the lead 41 of the electrical wire 40 to the conductor members 30 and the housing 10 and for preventing the lead 41 of the electrical wire 40 from being disengaged or detached or separated from the conductor members 30 and the housing 10. The ring members 33 of the conductor members 30 may then be cramped or clamped or distorted or deformed into various shapes and/or pinched onto the lead 41 of the electrical wire 40 for further solidly securing or mounting the lead 41 of the electrical wire 40 to the conductor members 30.

In assembling operation, as shown in FIGS. 1-3, the lead 41 of the electrical wire 40 may first be bent for about ninety (90) degrees and engaged with the casing 14 of the housing 10, and then extended and engaged with or through the opening 34 of the ring member 33 of the conductor member 30 and/or contacted or engaged with the housing 10, and the loop or curved or ring member 33 of the conductor member 30 may then be cramped or clamped or distorted or deformed into various shapes and/or pinched onto the lead 41 of the electrical wire 40 for solidly securing or mounting the lead 41 of the electrical wire 40 to the conductor members 30 without special tools or the other mounting machines.

Accordingly, the electric fixture or connector in accordance with the present invention includes an improved structure for easily and quickly and solidly connecting or coupling or assembling the electric wire to the conductor member or strip.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electric fixture comprising:
a housing including at least one orifice formed therein,
a conductor member including an end portion disposed and mounted in said at least one orifice of said housing, and including a ring member provided on said end portion of said conductor member, and including an opening formed in said ring member, and
an electrical wire including a lead engaged with said opening of said ring member and secured to said ring member by deforming said ring member.

2. The electric fixture as claimed in claim 1, wherein said conductor member includes at least one aperture formed therein, and said housing includes at least one pin formed therein and engaged with said at least one aperture of said conductor member for solidly anchoring and securing said conductor members to said housing.

3. The electric fixture as claimed in claim 1, wherein said housing includes a casing disposed beside said at least one orifice of said housing for engaging with said end portion of said conductor member, and for stably anchoring and securing said conductor member to said housing.

4. The electric fixture as claimed in claim 3, wherein said casing includes a slot formed therein for engaging with said lead of said electrical wire and for securing said lead of said electrical wire to said casing of said housing.

5. The electric fixture as claimed in claim 3, wherein said lead of said electrical wire is bent for ninety (90) degrees and extended and engaged through said opening of said ring member of said conductor member after said lead of said electrical wire is engaged with said casing.
